(19) United States
(12) Patent Application Publication
(10) Pub. No.: US 2026/0320569 A1
(43) Pub. Date: Oct. 15, 2026

(54) Decentralized Prize Allocation System

(71) Applicant: Paul L. Cazers, Plainwell, MI (US)

(72) Inventors: Paul L. Cazers, Plainwell, MI (US); Mike Fogg, Austin, TX (US)

(21) Appl. No.: 19/646,760

(22) Filed: Apr. 14, 2026

Related U.S. Application Data
(60) Provisional application No. 63/788,987, filed on Apr. 15, 2025.
(60) Provisional application No. 63/973,804, filed on Feb. 2, 2026.

(51) Int. Cl. G06Q 20/06; G07C 15/00

(52) U.S. Cl. CPC G06Q 20/065; G07C 15/00; G06Q 2220/00

(57) ABSTRACT

A method includes receiving a plurality of participant entries each including a cryptographic token and a predicted outcome of a real-world event. The method includes storing, by a smart contract deployed on a distributed ledger, the plurality of participant entries on the distributed ledger. The method includes obtaining, from an oracle, event data representing an actual outcome of the real-world event. The method includes determining, by the smart contract, at least one participant entry from the plurality of participant entries based on the predicted outcome of each of the plurality of participant entries and the actual outcome of the real-world event. The method includes distributing a digital asset to a user account associated with the at least one participant entry.

### CROSS REFERENCE TO RELATED APPLICATION

The present application claims priority of U.S. provisional application Ser. 63/973,804, filed Feb. 2, 2026, and U.S. provisional application Ser. No. 63/788,987, filed Apr. 15, 2025, which are hereby incorporated herein by reference in their entireties.

### TECHNICAL FIELD

This disclosure relates to a decentralized prize allocation system.

### BACKGROUND

Lottery systems have long been employed as a form of entertainment and a mechanism for distributing prizes based on random chance. Traditional lotteries typically rely on centralized authorities, such as government entities or private organizations, to manage ticket sales, draw winning numbers, and distribute prizes. While centralized systems have been effective for lotteries, centralized systems feature significant drawbacks. One major concern is the lack of transparency. The processes for ensuring randomness in drawings, securing ticket data, and managing funds are often opaque, leading to public skepticism about fairness and integrity. Another significant challenge is the susceptibility to fraud and manipulation. Centralized systems, by design, concentrate control in the hands of a few individuals or entities. Concentrated control creates potential vulnerabilities. Examples include insider manipulation of drawing results, fraudulent ticket claims, embezzlement of funds, and cybersecurity breaches that may compromise the entire system.

### SUMMARY

One aspect of the disclosure provides a computer-implemented method that when executed on data processing hardware causes the data processing hardware to perform operations. The operations include receiving a plurality of participant entries each including a cryptographic token and a predicted outcome of a real-world event. The operations include storing, by a smart contract deployed on a distributed ledger, the plurality of participant entries on the distributed ledger. The operations include obtaining, from an oracle, event data representing an actual outcome of the real-world event. The operations include determining, by the smart contract, at least one participant entry from the plurality of participant entries based on the predicted outcome of each of the plurality of participant entries and the actual outcome of the real-world event. The operations also include distributing a digital asset to a user account associated with the at least one participant entry.

Implementations of the disclosure may include one or more of the following optional features. In some implementations, the oracle is an independent data source external to the distributed ledger. The real-world event may include a government-regulated lottery drawing. In these implementations, the predicted outcome includes a selection of numbers corresponding to a number selection format of the government-regulated lottery drawing.

In some examples, the operations further include determining, by the smart contract, a location associated with the at least one participant entry, and performing, by the smart contract, an action on the digital asset based on the location. Determining the location associated with the at least one participant entry may include receiving an Internet Protocol (IP) address associated with the at least one participant entry, and determining the location based on a geolocation of the IP address. The operations may further include allocating a portion of the digital asset based on the location.

Optionally, the operations further include, after determining the at least one participant entry, destroying cryptographic tokens of participant entries not determined as the at least one participant entry. Destroying the cryptographic tokens may include setting a value associated with each cryptographic token to zero. In some implementations, the digital asset distributed to the user account is a portion of an aggregated value of the cryptographic tokens received in the plurality of participant entries.

Another aspect of the disclosure provides a system including data processing hardware and memory hardware in communication with the data processing hardware. The memory hardware stores instructions that when executed on the data processing hardware cause the data processing hardware to perform operations. The operations include receiving a plurality of participant entries each including a cryptographic token and a predicted outcome of a real-world event. The operations include storing, by a smart contract deployed on a distributed ledger, the plurality of participant entries on the distributed ledger. The operations include obtaining, from an oracle, event data representing an actual outcome of the real-world event. The operations include determining, by the smart contract, at least one participant entry from the plurality of participant entries based on the predicted outcome of each of the plurality of participant entries and the actual outcome of the real-world event. The operations also include distributing a digital asset to a user account associated with the at least one participant entry.

This aspect may include one or more of the following optional features. In some implementations, the oracle is an independent data source external to the distributed ledger. The real-world event may include a government-regulated lottery drawing. In these implementations, the predicted outcome includes a selection of numbers corresponding to a number selection format of the government-regulated lottery drawing.

In some examples, the operations further include determining, by the smart contract, a location associated with the at least one participant entry, and performing, by the smart contract, an action on the digital asset based on the location. Determining the location associated with the at least one participant entry may include receiving an Internet Protocol (IP) address associated with the at least one participant entry, and determining the location based on a geolocation of the IP address. The operations may further include allocating a portion of the digital asset based on the location.

Optionally, the operations further include, after determining the at least one participant entry, destroying cryptographic tokens of participant entries not determined as the at least one participant entry. Destroying the cryptographic tokens may include setting a value associated with each cryptographic token to zero. In some implementations, the digital asset distributed to the user account is a portion of an aggregated value of the cryptographic tokens received in the plurality of participant entries.

Another aspect of the disclosure provides a non-transitory computer-readable medium storing instructions that, when executed by data processing hardware, causes the data processing hardware to perform operations. The operations include receiving a plurality of participant entries each including a cryptographic token and a predicted outcome of a real-world event. The operations include storing, by a smart contract deployed on a distributed ledger, the plurality of participant entries on the distributed ledger. The operations include obtaining, from an oracle, event data representing an actual outcome of the real-world event. The operations include determining, by the smart contract, at least one participant entry from the plurality of participant entries based on the predicted outcome of each of the plurality of participant entries and the actual outcome of the real-world event. The operations also include distributing a digital asset to a user account associated with the at least one participant entry.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a decentralized prize allocation.

FIG. 2 is a flowchart of an example arrangement of operations for a computer-implemented method of decentralized prize allocation.

FIG. 3 is a schematic view of an example computing device that may be used to implement the systems and methods described herein.

Like reference symbols in the various drawings indicate like elements.

### DETAILED DESCRIPTION

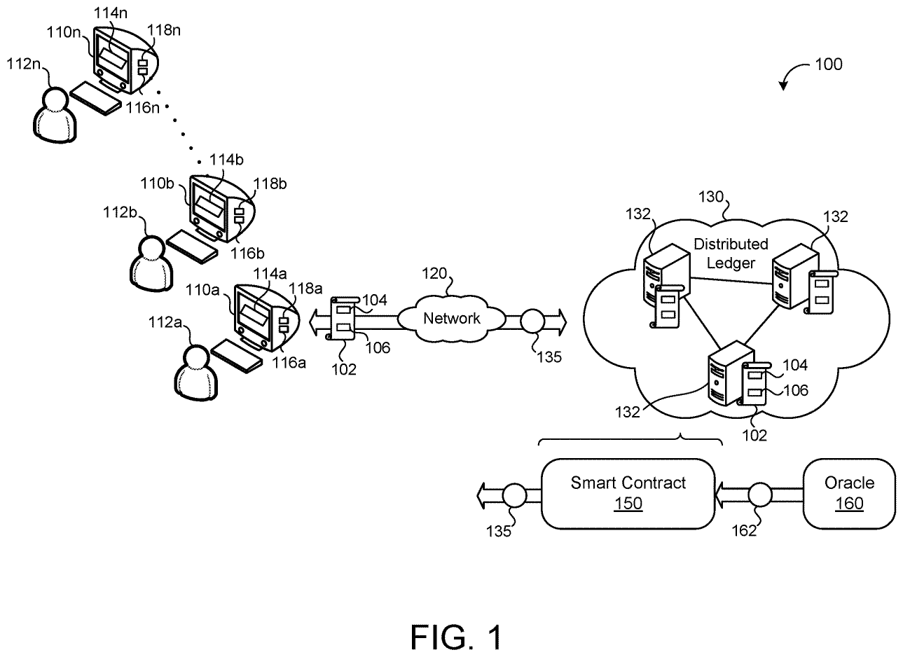

Referring to FIG. 1, in some implementations, an example system 100 for decentralized prize allocation includes a plurality of computing devices 110, 110a-n in communication with a distributed ledger 130 via a network 120. Each computing device 110 has computing resource 114 (e.g., data processing hardware) and/or storage resources 116 (e.g., memory hardware). Moreover, each computing device 110 may be a user device (e.g., a desktop workstation, a laptop workstation, or a mobile device or smart phone), a single computer (i.e., a server), multiple computers, or a distributed system (e.g., cloud environment). Each computing device 110 is associated with a respective participant 112 (e.g., user 112). Each computing device 110 is associated with and configured to access and manage a user account 114 (i.e., a digital wallet 114) stored on the distributed ledger 130 or accessible via the distributed ledger 130. The user account 114 may store and manage digital assets, such as cryptocurrencies or cryptographic tokens 104 (e.g., a non-fungible token (NFT)), associated with the participant 112.

Each participant 112 may create, via the computing device 110, a participant entry 102 and communicate the participant entry 102 with the distributed ledger 130. The distributed ledger 130 (i.e., a shared ledger or distributed ledger technology) is a consensus of digital data replicated and synchronized across multiple nodes 132. The distributed ledger 130 lacks a central administration or authority and instead relies on a consensus algorithm executed by at least a portion of the nodes 132 in a peer-to-peer network. The distributed ledger 130 receives a plurality of participant entries 102. The distributed ledger 130 may be a private distributed ledger or a public distributed ledger.

Thus, the distributed ledger 130 receives a plurality of participant entries 102 from the one or more computing devices 110. Each participant entry 102 includes a cryptographic token 104 and a predicted outcome 106 of a real-world event (e.g., lottery drawings, raffles). The cryptographic token 104 represents the payment provided by the participant to enter the game. The cryptographic token 104 may be a cryptographic token, cryptocurrency, or a custom token specific to the system. Notably, the use of cryptocurrency as the cryptographic token 104 enables a universal, decentralized currency. The decentralized nature of the cryptographic token 104 allows for universal commerce without the inefficiencies and costs associated with traditional currency exchange that enables participation from participants 112 across various geographic locations, regardless of their local currency (e.g., currency barriers).

In some implementations, the system 100 distinguishes between the asset used for payment (the cryptographic token 104) and the digital asset representing the ticket itself. For instance, the participant entry 102 may be generated or minted as a unique Non-Fungible Token (NFT). While the participant 112 may pay entry fees using fungible tokens (e.g., Ether, Bitcoin, or a stablecoin), the resulting participant entry 102 is instantiated as a separate, unique digital asset, such as an ERC-721A token or a similar non-fungible token standard suitable for the distributed ledger 130. Validating the participant entry 102 as a non-fungible token ensures that each entry has a unique token identifier while enabling the storage of specific metadata, such as the predicted outcome 106, directly on the distributed ledger 130. This structure allows the participant entry 102 to be individually owned, transferred, traded, or burned (destroyed) based on the mechanics of the game. For example, the system may deploy a specific ticket contract (e.g., an ERC-721A contract) that governs the minting and management of these ticket tokens. The use of a standard like ERC-721A may provide gas-efficiency benefits, particularly when a participant 112 mints multiple participant entries 102 in a single transaction (i.e., batch minting). While metadata may be stored directly on-chain, in preferred implementations to optimize computational storage costs, the detailed metadata of the participant entry 102 (e.g., graphical assets of the ticket, extensive historical data, or complex outcome arrays) is stored on a decentralized off-chain storage network, such as the InterPlanetary File System (IPFS) or Arweave. The smart contract 150 then stores only a cryptographic hash or a Uniform Resource Identifier (URI) pointing to this decentralized storage location. This hybrid storage approach ensures the immutable linkage between the NFT and its metadata without congesting the distributed ledger 130 with heavy data payloads.

In particular implementations, the cryptographic token 104 utilized for the participant entry 102, as well as the digital asset 135 distributed as the prize, comprises a stablecoin. A stablecoin is a class of cryptocurrency programmed to maintain a stable value relative to a specific reference asset, such as a fiat currency (e.g., the U.S. Dollar, utilizing tokens such as USDC or USDT) or a commodity. Utilizing stablecoins mitigates the volatility risks inherently associated with traditional, unpegged cryptocurrencies. For example, if a drawing period spans several days or weeks, holding the aggregated prize pool in a highly volatile cryptocurrency could result in a significant, unpredictable loss of fiat-equivalent value before the smart contract 150 executes the payout. By configuring the smart contract 150 to exclusively accept stablecoins, hold the aggregated prize pool in stablecoins, and distribute payouts in stablecoins, the system 100 ensures the value of the prize pool remains predictable and consistent. Furthermore, utilizing stablecoins streamlines the computational logic of the smart contract 150; for instance, fixed entry fees (e.g., a $2.00 ticket equivalent) can be programmatically hardcoded and enforced without requiring the smart contract 150 to continuously ping the oracle 160 for real-time fiat-to-crypto exchange rates, thereby reducing network congestion and transaction fees (e.g., gas costs).

To accommodate a global participant pool and process a high volume of participant entries 102 without incurring prohibitive transaction fees (i.e., “gas” costs), the distributed ledger 130 may comprise or interface with a Layer-2 (L2) scaling solution. Rather than executing every ticket purchase and smart contract 150 interaction directly on a base Layer-1 (L1) blockchain, the system 100 may utilize scaling protocols such as zero-knowledge rollups (ZK-Rollups) or optimistic rollups. In these implementations, the L2 network processes thousands of participant entry 102 minting transactions off-chain and subsequently batches them into a single cryptographic proof or compressed transaction data payload submitted to the underlying L1 network. This technical architecture increases the transaction throughput of the system 100, reduces computational overhead on the base layer, and ensures that the network fee associated with minting the cryptographic token 104 remains economically viable for micro-transactions, such as purchasing a single lottery ticket.

In some examples, the predicted outcome 106 corresponds to a selection of numbers that the participant 112 anticipates will match the winning numbers drawn in a particular, real-world lottery or raffle. This is analogous to a participant 112 selecting numbers on a traditional lottery ticket. For example, the predicted outcome 106 may be the numbers “10, 22, 34, 45, 56, and Powerball 12” for an upcoming Powerball drawing. One or more smart contracts 150 may be deployed on the distributed ledger 130. Each smart contract 150 is a self-executing contract that includes computer-executable code, with the terms of the contract governing the operation of the game written directly into the code. Responsive to receiving the plurality of participant entries 102, the smart contract 150 stores the plurality of participant entries 102 on the distributed ledger 130, securely and transparently recording each participant entry 102. This ensures that all participant entries 102 are recorded in an unalterable manner, preventing tampering and ensuring fairness.

The operation of the smart contract 150 may involve distinct lifecycle phases, including a setup phase, an implementation creation phase, and a drawing scheduling phase. During setup, the contract infrastructure is deployed to the distributed ledger 130. This may include deploying a main lottery contract and a separate ticket contract (e.g., the ERC-721A contract discussed above). The smart contract 150 connects to an address associated with the oracle 160 and configures parameters such as ticket price and payout percentages. Subsequently, the smart contract 150 may configure a specific lottery type. For example, the smart contract 150 may create a “Powerball Clone” by setting specific rules (e.g., number ranges, drawing frequency), defining prize tiers, and setting an identifier for the data source of the oracle 160.

The smart contract 150 obtains, from an oracle 160, event data 162 representing an actual outcome of the real-world event. The oracle 160 is a trusted and independent third-party data source or network external to the distributed ledger 130 that provides verified information about the real-world event. That is, the oracle 160 acts as a bridge between the real-world event and the distributed ledger 130, providing data that is immutable and verifiable. In some implementations, the oracle 160 may be a decentralized oracle network, such as Chainlink, that provides cryptographically signed data feeds, ensuring the integrity and authenticity of the data.

In other implementations, the oracle 160 may be an internal oracle network owned and/or operated by the administrator of the system 100. This internal oracle network may comprise a plurality of oracle servers (e.g., three or more servers). These oracle servers may be configured to function without required staking, operating as a trusted internal network. To ensure data accuracy and redundancy, each individual oracle server within the oracle 160 may be configured to fetch data from multiple, different, independent data source endpoints. For example, a single oracle server may fetch data from an official lottery API, a news agency feed, and a sports or news network API. Each oracle server then cross-validates the results across these disparate sources to ensure the data it possesses is accurate before communicating with the rest of the network. Once validated, the oracle 160 may format the event data 162 into a standardized results array (e.g., including an array of winning numbers, the special ball number, and a timestamp) for submission to the smart contract 150.

The system 100 may implement a quorum-based validation logic to resolve potential discrepancies between the oracle servers. For example, if the network includes five oracle servers, the logic may require a 3-of-5 quorum to validate the event data 162 (or a 5-of-7 quorum in larger networks). This validation logic allows for one or more data sources or servers to be offline or incorrect while still forcing a consensus among the majority of high-quality sources. In the rare event that a quorum cannot be reached (e.g., widespread data inconsistency where the threshold is not met), the system may default to a manual resolution process requiring human intervention.

The interaction between the smart contract 150 and the oracle 160 may follow an event-driven or “push” model. Rather than the oracle 160 constantly polling the ledger or the contract constantly requesting data, the smart contract 150 may emit a specific event, such as a “DrawingScheduled” event. This event contains relevant details like a lottery ID, a drawing ID, and a timestamp. The oracle 160 (or the individual servers constituting the oracle 160) listens for this specific event. Upon detecting the event, the oracle 160 adds the drawing to a monitoring queue and waits for the scheduled timestamp. Concurrently, the emission of the event may trigger the smart contract 150 to open ticket sales for that specific drawing ID and automatically establish a ticket sales cutoff time, ensuring no participant entries 102 are accepted after the real-world event has commenced. This event-driven architecture creates a robust, immutable audit trail on the distributed ledger 130. The logs associated with the emitted events persist on the ledger, allowing any party to verify exactly when a drawing was scheduled and when the oracle was triggered. Additionally, this model allows for efficiency, as the oracle 160 reacts instantly to the emitted event, while still retaining the ability to use “pull” functionality (e.g., getLogs) to backfill data or periodically check the state of the contract.

Because pending blockchain transactions are publicly visible in a mempool prior to validation, the smart contract 150 may, to technically prevent front-running or Miner Extractable Value (MEV) attacks, employ anti-front-running logic. For example, the smart contract 150 may enforce a cryptographic “commit-reveal” scheme, where a participant 112 first commits a hashed version of their predicted outcome 106, and only reveals the plaintext numbers in a subsequent block after the sales cutoff time has passed. Alternatively, the smart contract 150 may enforce a mandatory block-delay confirmation, mathematically requiring that the block height at which a participant entry 102 is minted strictly precedes the block height at which the oracle 160 initiates the transmission of the event data 162. Any participant entry 102 minted in the same block as, or after, the oracle update transaction is automatically reverted or disqualified by the smart contract 150.

In the context of a lottery, the oracle 160 provides the officially drawn winning numbers from the designated lottery, such as the Powerball or Mega Millions, directly to the smart contract 150. The smart contract 150 then automatically executes its programmed logic to determine at least one participant entry 102 (or potentially multiple winning entries, depending on the prize structure and pre-defined rules of the smart contract) from the plurality of participant entries 102 based on the predicted outcome 106 of each of the plurality of participant entries 102 and the actual outcome of the real-world event. For example, if the predicted outcome 106 of a participant entry 102 perfectly matches the actual outcome provided by the event data 162, that smart contract 150 identifies that participant entry 102 as a winner. Moreover, the smart contract 150 may define partial matches as winning entries, according to a payout schedule defined within the self-executing code of the smart contract 150. For example, matching only the Powerball number, or matching a certain number of regular numbers, may qualify for smaller prizes.

Notably, the system 100 leverages the established infrastructure and trusted integrity of existing governmental lotteries and multi-state lottery games, such as Mega Millions and Powerball. One of the fundamental issues with any lottery/raffle game is the integrity of the operation and veracity of the results. By linking the cryptographic token 104 to a state/multi-state lotteries' actual results, the distributed ledger 130 provides the derived benefit of the established, vetted, trusted integrity of the governmentally regulated game. The smart contract 150 is configured to accept predicted outcomes 106 that conform to the established rules of these pre-existing lotteries (e.g., selection of five numbers between 1 and 70, plus a Mega Ball number between 1 and 25 for Mega Millions). This maintains the efficacy of the proven probabilities and frequency of winning numbers associated with these established games. The distributed ledger 130 benefits from this existing foundation, including the established rules, drawing procedures, and payout structures, while adding the advantage of decentralized participation and increased prize pools. By enabling participation from participants 112 in various jurisdictions, including internationally where permissible, the total number of participants 120, and thus the aggregated cryptographic tokens 104 (e.g., the prize pool), may be significantly larger than a traditional lottery limited to a single state or nation. This leads to a larger prize amount, enhancing the attractiveness of the game.

The smart contract 150 automatically manages the increased prize pool and payout calculations based on the expanded participation. That is, since the smart contract 150 is deployed on the distributed ledger 130 (e.g., blockchain) participants 112 from multiple different territories may participate in the game. In short, the distributed ledger 130 enables a new structure of digital commercial assets. The distributed ledger 130 connects the real-world events (e.g., the lottery/raffle drawings) to an immutable blockchain vehicle (e.g., the cryptographic token 104). This structure provides all the benefits of a traditional lottery ticket within the territory of a game, but without the geographical, temporal (different time zones), language, and currency conversion barriers that typically restrict participation.

The distributed ledger 130, through the execution of the smart contracts 150, distributes a digital asset 135 to a user account 114 associated with the at least one winning participant entry 102. The digital asset 135 represents the winnings and may include, for example, a cryptocurrency (e.g., Ether, Bitcoin), a native token specific to the platform, or a portion of the aggregated cryptographic tokens 104 received from all participants as entry fees. Furthermore, the digital asset 135 is not limited to monetary or cryptocurrency payouts. The digital asset 135 may also comprise or represent non-monetary prizes. For instance, the digital asset 135 may be minted or transferred as a non-fungible token (NFT) representing verifiable ownership of, or a redemption voucher for, a physical good (e.g., a vehicle, electronics, merchandise), a digital collectible (e.g., digital artwork, in-game assets), a service, or a real-world experience. In these implementations, the automated distribution of the digital asset 135 by the smart contract 150 acts as the transfer of title or redemption rights to the winning participant 112, who may subsequently hold, trade, or redeem the digital asset 135 via an off-chain fulfillment process.

In some implementations, the system 100 integrates directly with the Real-World Asset (RWA) tokenization market to provide asset-backed digital assets 135 as prizes. RWA tokenization involves representing physical assets or traditional financial instruments (e.g., real estate, commodities such as tokenized gold, equities, or government treasury bills) as cryptographic tokens on the distributed ledger 130. By leveraging the RWA tokenization market, the smart contract 150 may be configured to distribute a prize comprising one or more RWA tokens. For example, rather than a lump sum of volatile cryptocurrency, a winning participant 112 may receive a digital asset 135 representing fractional ownership of a commercial real estate property or a yield-bearing tokenized bond. To achieve this, the smart contract 150 may be programmed to interface via cross-contract calls with established RWA protocol smart contracts, executing a programmatic transfer of the tokenized asset rights to the user account 114 upon verification of the winning predicted outcome 106. This integration bridges traditional finance (TradFi) and physical assets with the decentralized prize allocation system, allowing the system to offer stable, yield-generating, or intrinsically valuable asset-backed prizes.

The specific type and amount of the digital asset 135 are determined by the pre-defined payout rules encoded within the smart contract 150. The user account 114, to which the digital asset is transferred, may be a cryptographic wallet or other secure digital asset storage mechanism accessible by the winning participant 112. The user account 114 may be accessed via an application, such as a digital wallet, executing on the computing device 110. Notably, the transfer of the digital asset 135 is executed automatically by the smart contract 150 upon determination of a winning entry, ensuring a transparent and immutable payout process, consistent with the predefined rules. Advantageously, the automated distribution of the digital asset 135 may ensure that no winning participant entries 102 go unclaimed. For instance, there is no action required by the participant 112 to claim the prize. The logic of the smart contract 150 may include direct transfer instructions that are triggered when the winning criteria are met. This eliminates the possibility of unclaimed prizes due to lost tickets, forgotten entries, or participant inaction.

To ensure regulatory compliance, the smart contract 150 may be programmed to automatically enforce a comprehensive set of rules derived from relevant jurisdictional regulations. These regulations may span local, state, federal, and international levels, addressing diverse aspects of the real-world event. Key areas of automated compliance may include geographic restrictions, tax withholding and reporting, fee allocation, and non-profit compliance. In particular, the smart contract 150 may restrict participation based on geographic location. For example, participants 112 located in jurisdictions where online lotteries or similar games are prohibited may be automatically excluded. The smart contract 150 may achieve geographic restrictions using techniques such as Internet Protocol (IP) address geolocation, which estimates a location of a participant 112 based on their IP address, and/or robust Know Your Customer (KYC), which may involve verifying the identity and address of the participant 112 through submitted documentation. This functionality mirrors the geofencing employed by existing state-operated online lottery systems, which restrict ticket sales to participants physically present within the boundaries of the state. In some implementations, the smart contract 150 may automatically calculate and withhold the appropriate taxes on winnings, based on the jurisdiction of the winner and the prize amount. This withheld amount is then securely stored and subsequently remitted to the relevant tax authorities, along with the necessary reporting documentation, such as digital equivalents of forms GC-2A, GC-2B, and GC-7R, as may be required by the New York State Gaming Commission, or analogous forms in other jurisdictions. Different procedures may be automatically triggered based on prize thresholds. For example, prizes exceeding a certain amount (e.g., $30,000) may necessitate more detailed reporting and withholding (Category 1A in New York).

Moreover, the smart contract 150 may be programmed to automatically allocate a predetermined portion of the entry fees (represented by the cryptographic tokens 104) to designated government agencies, fulfilling any licensing or regulatory fee requirements. The smart contract 150 performs allocation transparently by recording the allocation on the distributed ledger 130. In some examples, the smart contract 150 may ensure compliance with relevant regulations if the game is operated by or on behalf of a non-profit organization. Ensuring compliance may involve the smart contract 150 automatically allocating a specified percentage of the proceeds to designated charitable organizations or government entities, as defined by applicable regulations defined within the smart contract 150. The smart contract 150 may also generate the necessary reports for compliance filings. The automated compliance mechanism, inherent in the code of the smart contract 150, provides a significant advancement over traditional lottery systems by enhancing transparency, efficiency, and auditability. The immutable nature of the distributed ledger 130 ensures that all compliance actions are permanently and verifiably recorded.

In further implementations, the smart contract 150 may be programmed to automatically enforce compliance with federal and international economic and trade sanctions, such as those administered by the Office of Foreign Assets Control (OFAC). To ensure such anti-money laundering (AML) and sanctions compliance, the smart contract 150 may interface with a compliance oracle (which may be the same as or distinct from oracle 160) configured to screen participant data, IP addresses, or digital wallet addresses associated with the user account 114. For example, before permitting the minting of a participant entry 102 or before distributing the digital asset 135 (e.g., a prize payout), the smart contract 150 queries the compliance oracle to verify that the participant 112 is not listed on a sanctions list, such as the Specially Designated Nationals and Blocked Persons (SDN) list, and is not operating from a comprehensively sanctioned jurisdiction. If the compliance oracle returns a flagged status, the smart contract 150 automatically executes a restrictive action. This restrictive action may include reverting the transaction attempting to create the participant entry 102, blocking the transfer of the digital asset 135, or routing the associated cryptographic token 104 into a locked, on-chain escrow account pending manual regulatory review or resolution. By integrating real-time or event-driven sanctions screening directly into the self-executing code, the system 100 prevents the illicit transfer of value to prohibited entities without requiring centralized, manual transaction-by-transaction approval.

To prevent misuse and ensure fairness after a drawing, the smart contract 150 may be programmed to self-burn or destruct participant entries 102 once the associated real-world event has concluded. The destruction of the participant entries 102 renders the cryptographic tokens 104 or the specific ticket tokens (e.g., the NFTs representing the participant entries 102) associated with losing participant entries 102 unusable, effectively removing them from circulation and preventing them from being re-used or entered into subsequent drawings. The smart contract 150 achieves this by executing a function that irrevocably alters the state of the participant entry 102 or its associated token. Because the participant entry 102 may be an NFT with a specific token ID, the smart contract 150 may execute a burn function specific to that token ID, or move the token to a “burn address” where it cannot be retrieved (i.e., an address where the associated keys are unknown). The self-destruction mechanism may be triggered automatically by the smart contract 150 upon receiving the actual outcome of the real-world event from the oracle 160. This ensures that expired participant entries 102 cannot be re-used, maintaining the integrity of the game and preventing potential fraud.

As such, the system 100 facilitates global participation in established, real-world lotteries and raffles (e.g., US Mega Millions, Power Ball) through a digital platform. The participant entries 102 act as digital “tickets,” representing an entry into a prize pool, with winning numbers directly tied to the results of a specific, contemporaneous, and verifiable real-world lottery drawing via a blockchain oracle 160 (e.g., Chainlink or a proprietary internal network). This allows participants 112 worldwide, regardless of location or currency, to participate, expanding the potential prize pool. The distributed ledger 130 leverages the universality of cryptocurrency and eliminates currency exchange issues, providing access through existing blockchain infrastructure.

Notably, the distributed ledger 130 employs smart contracts 150 to programmatically manage and ensure compliance with diverse lottery/raffle regulations (local, state, national, international). These self-executing smart contracts 150 automate functions like fee/tax calculations, prize thresholds, and adherence to non-profit operational rules. Moreover, the smart contracts 150 also enforce geo-restrictions and enable “self-burning” cryptographic tokens 104 or ticket tokens post-drawing, preventing reuse. The system 100 leverages the existing integrity and rules of established government lotteries, inheriting their trustworthiness while overcoming traditional barriers (geography, time zones, currency). The result is a globally accessible digital asset structure directly tied to verifiable real-world lottery outcomes, combining the benefits of established lotteries with the decentralized, borderless nature of blockchain technology.

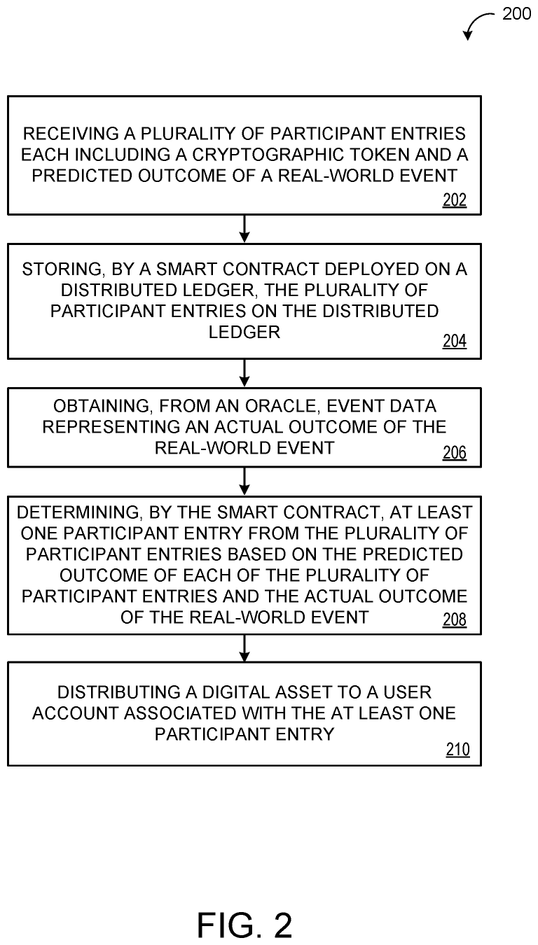

FIG. 2 is a flowchart of an exemplary arrangement of operations for a method 200 of decentralized prize allocation. At operation 202, the method 200 includes receiving a plurality of participant entries 102 each including a cryptographic token 104 and a predicted outcome 106 of a real-world event. At operation 204, the method 200 includes storing, by a smart contract 150 deployed on a distributed ledger 130, the plurality of participant entries 102 on the distributed ledger 130. At operation 206, the method 200 includes obtaining, from an oracle 160, event data 162 representing an actual outcome of the real-world event. At operation 208, the method 200 includes determining, by the smart contract 150, at least one participant entry 102 from the plurality of participant entries 102 based on the predicted outcome 106 of each of the plurality of participant entries 102 and the actual outcome of the real-world event. At operation 210, the method 200 includes distributing a digital asset 135 to user account 114 associated with the at least one participant entry 102.

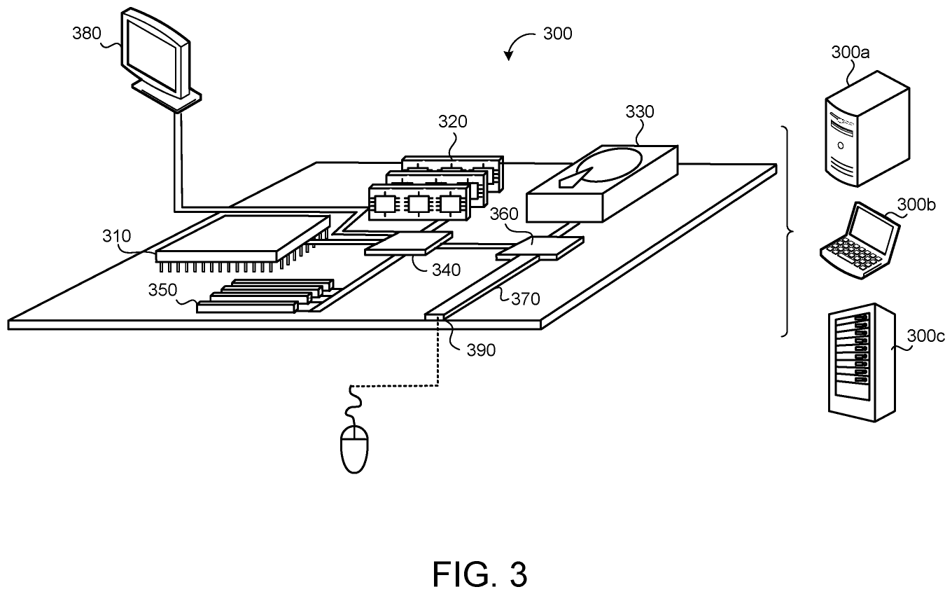

FIG. 3 is a schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving a plurality of participant entries each comprising a cryptographic token and a predicted outcome of a real-world event;
storing, by a smart contract deployed on a distributed ledger, the plurality of participant entries on the distributed ledger;
obtaining, from an oracle, event data representing an actual outcome of the real-world event;
determining, by the smart contract, at least one participant entry from the plurality of participant entries based on the predicted outcome of each of the plurality of participant entries and the actual outcome of the real-world event; and
distributing a digital asset to a user account associated with the at least one participant entry.

2. The method of claim 1, wherein the oracle is an independent data source external to the distributed ledger.

3. The method of claim 1, wherein the real-world event comprises a government-regulated lottery drawing.

4. The method of claim 3, wherein the predicted outcome comprises a selection of numbers corresponding to a number selection format of the government-regulated lottery drawing.

5. The method of claim 1, wherein the operations further comprise:
determining, by the smart contract, a location associated with the at least one participant entry; and
performing, by the smart contract, an action on the digital asset based on the location.

6. The method of claim 5, wherein determining the location associated with the at least one participant entry comprises:
receiving an Internet Protocol (IP) address associated with the at least one participant entry; and
determining the location based on a geolocation of the IP address.

7. The method of claim 5, wherein the operations further comprise allocating a portion of the digital asset based on the location.

8. The method of claim 1, wherein the operations further comprise, after determining the at least one participant entry, destroying cryptographic tokens of participant entries not determined as the at least one participant entry.

9. The method of claim 8, wherein destroying the cryptographic tokens comprises setting a value associated with each cryptographic token to zero.

10. The method of claim 1, wherein the digital asset distributed to the user account is a portion of an aggregated value of the cryptographic tokens received in the plurality of participant entries.

11. A system comprising:
data processing hardware; and
memory hardware in communication with the data processing hardware, the memory hardware storing instructions that when executed on the data processing hardware cause the data processing hardware to perform operations comprising:
receiving a plurality of participant entries each comprising a cryptographic token and a predicted outcome of a real-world event;
storing, by a smart contract deployed on a distributed ledger, the plurality of participant entries on the distributed ledger;
obtaining, from an oracle, event data representing an actual outcome of the real-world event;
determining, by the smart contract, at least one participant entry from the plurality of participant entries based on the predicted outcome of each of the plurality of participant entries and the actual outcome of the real-world event; and
distributing a digital asset to a user account associated with the at least one participant entry.

12. The system of claim 11, wherein the oracle is an independent data source external to the distributed ledger.

13. The system of claim 11, wherein the real-world event comprises a government-regulated lottery drawing.

14. The system of claim 13, wherein the predicted outcome comprises a selection of numbers corresponding to a number selection format of the government-regulated lottery drawing.

15. The system of claim 11, wherein the operations further comprise:
determining, by the smart contract, a location associated with the at least one participant entry; and
performing, by the smart contract, an action on the digital asset based on the location.

16. The system of claim 15, wherein determining the location associated with the at least one participant entry comprises:
receiving an Internet Protocol (IP) address associated with the at least one participant entry; and
determining the location based on a geolocation of the IP address.

17. The system of claim 15, wherein the operations further comprise allocating a portion of the digital asset based on the location.

18. The system of claim 11, wherein the operations further comprise, after determining the at least one participant entry, destroying cryptographic tokens of participant entries not determined as the at least one participant entry.

19. The system of claim 18, wherein destroying the cryptographic tokens comprises setting a value associated with each cryptographic token to zero.

20. A non-transitory computer-readable medium storing instructions that, when executed by data processing hardware, cause the data processing hardware to perform operations comprising:
receiving a plurality of participant entries each comprising a cryptographic token and a predicted outcome of a real-world event;
storing, by a smart contract deployed on a distributed ledger, the plurality of participant entries on the distributed ledger;
obtaining, from an oracle, event data representing an actual outcome of the real-world event;
determining, by the smart contract, at least one participant entry from the plurality of participant entries based on the predicted outcome of each of the plurality of participant entries and the actual outcome of the real-world event; and
distributing a digital asset to a user account associated with the at least one participant entry.
